(19) United States
(12) Patent Application Publication
(10) Pub. No.: US 2025/0382763 A1
(43) Pub. Date: Dec. 18, 2025

(54) OFFSHORE WIND TURBINE JACKET FOUNDATION CAPABLE WITH ADJUSTABLE NATURAL FREQUENCY AND MOTION DAMPING AND CONTROL METHOD THEREOF

(71) Applicant: POWERCHINA Huadong Engineering Corporation Limited, Hangzhou (CN)

(72) Inventors: Kanmin SHEN, Hangzhou (CN); Zhigang SHAN, Hangzhou (CN); Zhenhao SHI, Hangzhou (CN); Bin WANG, Hangzhou (CN); Maosong HUANG, Hangzhou (CN); Peng PENG, Hangzhou (CN); Miaojun SUN, Hangzhou (CN); He CUI, Hangzhou (CN); Senjie TONG, Hangzhou (CN)

(21) Appl. No.: 18/945,481

(22) Filed: Nov. 12, 2024

(30) Foreign Application Priority Data
Jun. 13, 2024 (CN) 202410762029.7

(51) Int. Cl. E02B 17/02; E02B 17/00; F03D 13/25

(52) U.S. Cl. CPC E02B 17/024; F03D 13/25; E02B 2017/0091; F05B 2240/95

(57) ABSTRACT

An offshore wind turbine jacket foundation capable with adjustable natural frequency and motion damping and a control method, comprising: a jacket; a tuned liquid damper system, comprising a central liquid tank communicated with seawater and distributed liquid tanks, wherein the central liquid tank and the distributed liquid tanks carry out liquid delivery through pipelines; a flow monitoring and control system configured to obtain storage information of each liquid tank by data acquisition; an acceleration data acquisition and analysis system configured to acquire acceleration data at key nodes of the jacket foundation; the pump on each pipeline is controlled based on the obtained data to realize the redistribution adjustment of the liquid storage and liquid level of each liquid tank in the damper system in a short time, and the mass distribution of the jacket structure as a whole is adjusted, so as to adjust the natural frequency and motion damping.

### CROSS-REFERENCE TO RELATED APPLICATIONS

The present application claims priority to Chinese Patent Application No. 202410762029.7, filed on Jun. 13, 2024, the content of which is incorporated herein by reference in its entirety.

### TECHNICAL FIELD

The present disclosure relates to the technical field of offshore wind turbine foundation, and in particular, to an offshore wind turbine jacket foundation capable with adjustable natural frequency and motion damping and a control method.

### BACKGROUND

With the development of offshore wind power to large-scale and far-reaching sea, jacket foundation, as a wind turbine foundation with a water depth of more than 50 m, has broad application prospects. However, the jacket foundation in place is vulnerable to strong external dynamic loads such as wind waves, wave currents and earthquakes. When the external dynamic load frequency is close to the natural frequency of the wind turbine foundation, the wind turbine structure will have a large deformation response due to resonance, thereby affecting the normal operation and service life of the wind turbine. A tuned liquid damper is a system composed of water tank and liquid therein, which can attenuate the vibration of main structure through liquid inertia force and dynamic pressure difference, and has been initially applied in vibration control of high-rise structures (e.g., chimney towers and wind turbine towers). However, the current tuned liquid damper is usually a closed water tank, so the liquid storage volume and liquid level are relatively fixed, resulting in a narrow effective damping frequency range, which is difficult to adjust in real time according to changes in the external load frequency. In addition, a small number of connected ballast tanks with adjustable liquid reserves are mainly aimed at floating wind turbine platforms. There is no targeted design method for the tuned liquid damping system for jacket, a basic form with large foundation stiffness and mass. Therefore, designing a jacket foundation with adjustable natural frequency and motion damping is of great engineering application value for improving the operation stability and service life of offshore wind turbines.

The difficulty of design lies in how to arrange and design the liquid tank of jacket damper system, and how to take more rapid and effective measures to adjust the natural frequency of the foundation on the premise of real-time detection of the acceleration of jacket nodes. This is the issue that this application focuses on.

### SUMMARY

The present disclosure aims to design an offshore wind turbine jacket foundation capable with adjustable natural frequency and motion damping, and a control method thereof. By rationalizing the liquid tank and control device design for a damper system, the present disclosure designs the layout and control solution of the liquid tank according to the deformation mode of the jacket foundation, and can actively control and adjust the natural frequency of the foundation and its motion damping in real time.

The technical solution of the present disclosure is as follows:
an offshore wind turbine jacket foundation capable with adjustable natural frequency and motion damping includes a jacket, a tuned liquid damper system, a flow monitoring and control system and an acceleration data acquisition and analysis system;
the tuned liquid damper system includes a central liquid tank installed on a bottom surface of a working platform at the top of the jacket, and a plurality of distributed liquid tanks arranged at the nodes of the jacket; the central liquid tank and the distributed liquid tanks are connected through pipelines and communicated with seawater, and each pipeline is provided with a flowmeter and controls liquid transportation by a pump; the acceleration data acquisition and analysis system includes acceleration acquisition devices and a data processing system; the acceleration acquisition devices are arranged at key nodes of the jacket foundation and transmit the acquired data to the data processing system; the flow monitoring and control system includes the flowmeter, the pump, a data acquisition instrument and a liquid level gauge arranged in each distributed liquid tank; the data acquisition instrument transmits the acquired data to the data processing system, and the pump on each pipeline is controlled according to a processing result of the data processing system, so as to realize a redistribution adjustment of liquid storage volumes and liquid levels of seawater in the central liquid tank and each distributed liquid tank, and adjust an overall mass distribution of a structure of the jacket to realize an adjustment and control of the natural frequency and the motion damping of the structure.

Further, a side wall of each distributed liquid tank is connected to an interlayer infusion pipeline, an interlayer reflux pipeline and an intralayer infusion pipeline configured to connect distributed liquid tanks at lower layers, distributed liquid tanks at upper layers and distributed liquid tanks at a same layer, respectively. The central liquid tank is configured to directly extract seawater to complete liquid storage, and no return pipe is provided between a uppermost distributed liquid tank and the central liquid tank, and the interlayer infusion pipeline of a lowermost distributed liquid tank is directly connected to seawater, facilitating the tuned liquid damper system to discharge excess liquid quickly.

Further, a filter grid is arranged in the central liquid tank to divide an inner space of the central liquid tank into an upper layer and a lower layer; the upper layer is a liquid storage chamber and the lower layer is a sediment deposition chamber; the sediment deposition chamber is connected with seawater through a pumping pipeline, and the liquid storage chamber is connected with the distributed liquid tank through a water transmission pipeline.

The central liquid tank sucks seawater through a central pumping pipeline, sediment separation and liquid filtration are implemented in the sediment deposition chamber, and liquid is injected into the liquid storage chamber; the central liquid tank transports the liquid through the central water transmission pipeline to the uppermost distributed liquid tank, and when the liquid storage demand is met, the excess liquid is transported downward layer by layer through the interlayer infusion pipeline to the distributed liquid tanks at the lower layers; the lowermost distributed liquid tank does not only receive an infusion from the distributed liquid tanks at the upper layers, but also discharges the excess liquid in the tuned liquid damper system back to the ocean through the interlayer infusion pipeline of the lowermost distributed liquid tank; and horizontal liquid delivery is carried out between distributed liquid tanks in the same layer through the intralayer infusion pipeline, and liquid backflow replenishment is realized between two adjacent distributed liquid tanks through the interlayer reflux pipeline.

Further, a sliding rail is fixed at the filter grid, and an M-shaped perforated folding plate is provided in the liquid storage chamber; the M-shaped perforated folding plate is formed by sequentially hinging multiple perforated plates through cylindrical hinges; two ends of the M-shaped perforated folding plate are provided with sliding blocks, and the sliding blocks are arranged in the sliding rail and move along the sliding rail; a waterproof rubber strip and multiple waterproof rubber protrusions are fixed at the filter grid; a bottom of the central liquid tank is an openable baffle; the central liquid tank further includes a central electronic control system configured to control a movement of the sliding blocks to fold or unfold the M-shaped perforated folding plate and control an opening and closing of the openable baffle; and when the M-shaped perforated folding plate is unfolded and flattened, hole positions at the M-shaped perforated folding plate correspond exactly to the waterproof rubber protrusions one by one, and the waterproof rubber protrusions are embedded in holes to completely isolate the liquid storage chamber from the sediment deposition chamber together with the waterproof rubber strip.

Further, when a capacity of the sediment deposition chamber is insufficient, the central electronic control system controls the M-shaped perforated folding plate to be stretched and laid flat at the filter grid; when the M-shaped perforated folding plate is completely laid flat, the waterproof rubber protrusions at the filter grid 21 are completely embedded in the holes of the M-shaped perforated folding plate, and completely isolate the liquid storage chamber from the sediment deposition chamber together with the waterproof rubber strip, that is, the filtered liquid is completely sealed in the liquid storage chamber; the openable baffle at the bottom of the central liquid tank is opened by the central electronic control system to discharge sediment back into seawater; and after the sediment is discharged into seawater, the central electronic control system closes the openable baffle and retracts the M-shaped perforated folding plate.

Further, damping nets in different directions are provided in the distributed liquid tanks, and the M-shaped perforated folding plate in a folded state and the damping nets are configured to increase a resistance generated by liquid sloshing when the structure vibrates.

Further, stiffening plates and horizontal stiffening rods are additionally welded at the nodes of the jacket for installing and fixing the distributed liquid tanks.

Further, the data acquisition instrument and the data processing system are integrated into the central control system in an offshore wind turbine cabin; the data acquisition instrument acquires data of each flowmeter and liquid level gauge, and calculates a current liquid storage volume of each distributed liquid tank to obtain a damping distribution; and the data processing system obtains an optimal solution of the natural frequency and the motion damping for adjusting the structure based on the natural frequency and the damping distribution of the current jacket by combining acceleration parameters measured at each node of the jacket, and transmits an adjusted liquid demand of each distributed liquid tank to the flow monitoring and control system to control pumping and discharging of each pump and complete a quality and damping redistribution of the tuned liquid damper system.

A control method for the above offshore wind turbine jacket foundation capable with adjustable natural frequency and motion damping is provided. The jacket foundation adjusts the natural frequency and motion damping of the structure in real time, and the control method includes the following steps:
pumping, by the central liquid tank, seawater, filtering the seawater through the filter grid and entering the liquid storage chamber, standing and separating sediment in the seawater, and leaving the sediment in the sediment deposition chamber; after the liquid storage volume of the central liquid tank reaches a required value, flowing the excess liquid into the distributed liquid tanks below layer by layer through the water transmission pipeline; when the liquid in each distributed liquid tank is filled, the flow monitoring and control system obtaining a current liquid storage volume of each distributed liquid tank according to data measured by each flowmeter and liquid level gauge, and adjusting a liquid mass distribution proportion in each distributed liquid tank according to an overall mass and the natural frequency of the jacket to control a ratio of the natural frequency of the tuned liquid damper to an overall first-order natural frequency of the jacket to be 0.9-1.1 and a ratio of a total mass of the tuned liquid damper to an overall mass of the jacket to be 1.7%-2.3%;
when the structure of the jacket generates a vibration response under an action of an external dynamic load, calculating, by the acceleration data acquisition and analysis system, a current external load frequency by acquiring acceleration data at the top and key nodes of the jacket, obtaining an optimal solution of the adjusted natural frequency and damping distribution of the jacket according to the natural frequency and damping distribution of the structure of the current jacket, and transmitting a reference value of the liquid storage volume required by each distributed liquid tank to the flow monitoring and control system; and
controlling, by the flow monitoring and control system, each pump to complete liquid pumping and discharging activities of the central liquid tank and each distributed liquid tank according to the current liquid storage volume and the reference value of the required liquid storage volume, and realizing the redistribution adjustment of the liquid storage volumes of the central liquid tank and each distributed liquid tank, thereby reducing an influence of the external dynamic load on an overall stability of the structure in time.

The present disclosure has the following beneficial effects: according to the present disclosure, the pretreatment, storage and transportation of seawater are realized through the central liquid tank, and the inconvenience caused by pre-filling the closed damping liquid to construction and subsequent operation and maintenance is avoided. The mass and damping redistribution adjustment of the damper system can be completed in a short time through different types of infusion reflux pipelines set in advance among the liquid tanks. The flow monitoring and control system cooperates with the acceleration output acquisition system, and the motion damping at each node and the overall natural frequency of the jacket are monitored and adjusted in real time according to the node acceleration and vibration frequency of the current jacket structure, so as to minimize the influence of external load frequency change on the structural stability. The jacket foundation material is environment-friendly, convenient for construction, convenient for operation and accurate for control.

### BRIEF DESCRIPTION OF DRAWINGS

The accompanying drawings, which constitute a part of this application, are used to provide a further understanding of the present disclosure, and the illustrative embodiments of the present disclosure and their descriptions are intended to explain the present disclosure, and do not constitute undue limitations on the present disclosure. In the attached drawings:

FIG. 1 is an overall schematic diagram of offshore wind turbine jacket foundation in a specific example of the present disclosure.

FIG. 2 is a three-dimensional schematic diagram of jacket node reinforcement and liquid tank arrangement in a specific example of the present disclosure.

FIG. 3 is a schematic plan view of the structure of a central liquid tank in a specific example of the present disclosure.

FIG. 4 is a three-dimensional schematic diagram of the structure of the central liquid tank in a specific example of the present disclosure.

FIG. 5 is a schematic plan view of the structure of a distributed liquid tank in a specific example of the present disclosure.

Reference signs:

| | |
|---|---|
| 1-Wind turbine tower and upper support; | 2-Working platform; |
| 3-Jacket; | 4-Central liquid tank; |
| 5-Distributed liquid tank; | 6-Central pumping pipeline; |
| 7-Central water transmission pipeline; | 8-Interlayer water transmission pipeline; |
| 9-Interlayer reflux pipeline; | 10-Intralayer infusion pipeline; |
| 11-Flowmeter; | 12-Stiffening plate; |
| 13-Horizontal stiffening rod; | 14-Liquid storage chamber |
| 15-Sediment deposition chamber; | 16-M-shaped perforated folding plate; |
| 17-Cylindrical hinge; | 18-Drainage hole; |
| 19-Sliding block; | 20-Slide rail; |
| 21-Filter grid; | 22-Openable lower baffle plate; |
| 23-Waterproof rubber joint; | 24-Water pump; |
| 25-Triaxial accelerometer; | 26-Waterproof rubber protrusion; |
| 27-Waterproof rubber strip; | 28-Damping net; |
| 29-Liquid level gauge. | |

### DESCRIPTION OF EMBODIMENTS

Embodiments of the present disclosure will be described in detail below with reference to the drawings.

The present disclosure relates to a jacket foundation form with adjustable natural frequency and motion damping, which includes a jacket structure, a tuned liquid damper system, a flow monitoring and control system and an acceleration data acquisition and analysis system.

The jacket structure is the main part of the foundation form, and its material is mainly steel. Different from the jacket foundation used in common projects, the jacket structure is welded with stiffening plates and horizontal stiffening rods at the jacket nodes to meet the requirements of convenience in installation of the liquid storage tank and structural safety, so as to avoid local buckling of the jacket structure caused by high liquid storage volume or heavy load. The liquid tank is fixed on the stiffening plate, and is firmly connected with the stiffening plate and the horizontal stiffening rod of the jacket by means of welding and screw fixation to achieve firm connection.

The tuned liquid damper system is the core part to realize the adjustment of foundation natural frequency and motion damping. The tuned liquid damper system consists of a central liquid tank installed at the bottom of the working platform, several distributed liquid tanks arranged at the nodes of jacket and infusion reflux pipeline s between the liquid tanks. The central liquid tank sucks seawater through the pipeline, completes sediment separation and liquid filtration in the sediment deposition chamber, and injects the liquid required by the damper into the liquid storage chamber of the central liquid tank. Liquid delivery is carried out for the top distributed liquid tank by the central liquid tank through the pipeline, and when the liquid storage demand is met, the excess liquid is delivered down to the distributed liquid tanks at the lower layers through the pipeline. The lowest distributed liquid tank does not only receive the infusion from the upper distributed liquid tank, but also discharges the excess liquid in the system back to the ocean through the pipeline. Horizontal liquid delivery is carried out between distributed liquid tanks in the same layer through intralayer infusion reflux pipelines, and liquid backflow replenishment is realized between two adjacent distributed liquid tanks through interlayer reflux pipelines, so that the liquid storage volume and liquid level of each liquid tank in the damper system can be redistributed and adjusted in a short time.

The mass distribution of the jacket structure as a whole can be adjusted by changing the liquid storage volume in each tank, so as to realize the adjustment and control of the natural frequency and motion damping of the structure. The liquid in the liquid tank is usually not full, and the inertia force and dynamic pressure difference of the liquid when the structure vibrates, combined with the damping net arranged in the liquid tank, consume the vibration energy to achieve the vibration damping effect, and the motion damping at the nodes of the jacket structure can be changed by adjusting and controlling the liquid storage volume in each liquid tank.

The flow monitoring and control system includes a liquid level gauge, a flowmeter, a water pump and a data acquisition instrument. The liquid level gauge is arranged in each distributed liquid tank and used for measuring the real-time liquid level height in the bin, and then used for calculating the mass distribution and motion damping of each liquid tank. The flowmeter is arranged on the liquid delivery pipeline and used for measuring the amount of liquid flowing into and out of each liquid tank. According to an example of the present disclosure, the water pump can be arranged at the end position of the liquid pumping and infusion pipeline of the liquid tank for pumping the liquid into each liquid tank; The data acquisition instrument can be integrated into the central control system in the cabin at the top of the wind turbine, and the current liquid storage volume in each liquid tank can be calculated through the data of each flowmeter and liquid level gauge. The flow monitoring and control system can also include an integrated control program for the operation of each water pump, which can control the pumping capacity of the water pump based on the liquid level demand reference quantity, infusion and drainage parameters of each liquid tank transmitted by the acceleration data acquisition and analysis system, and can also perform calibration in combination with the monitoring data of the flowmeter.

The acceleration data acquisition and analysis system consists of an acceleration acquisition device such as a triaxial accelerometer and an acceleration data processing system. A plurality of triaxial accelerometers are arranged at the jacket nodes and the outer wall of each liquid tank. The acceleration data processing system can be integrated into the central control system in the cabin at the top of the fan. The acceleration data processing system calculates the overall vibration frequency of the current jacket structure according to the acceleration of the jacket nodes collected by the accelerometers, and then calculates the optimal solution for adjusting the mass distribution of the liquid tanks according to the preset adjustment rules, and transmits the infusion volume and drainage volume of each liquid tank to the flow monitoring and control system in combination with the motion damping distribution and control indicators of each node, so as to realize the real-time adjustment of the natural frequency and motion damping of the jacket foundation.

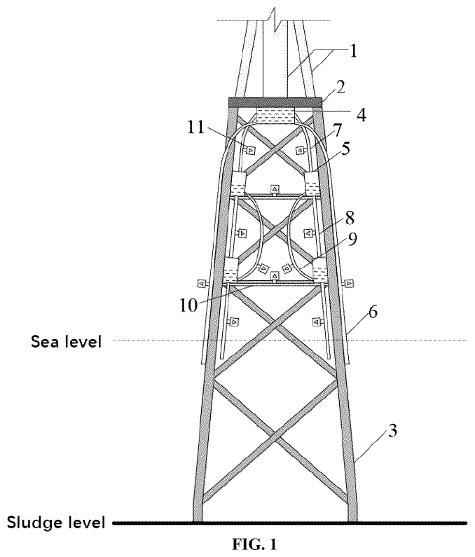

FIGS. 1 to 5 are a concrete example of the present disclosure, specifically:

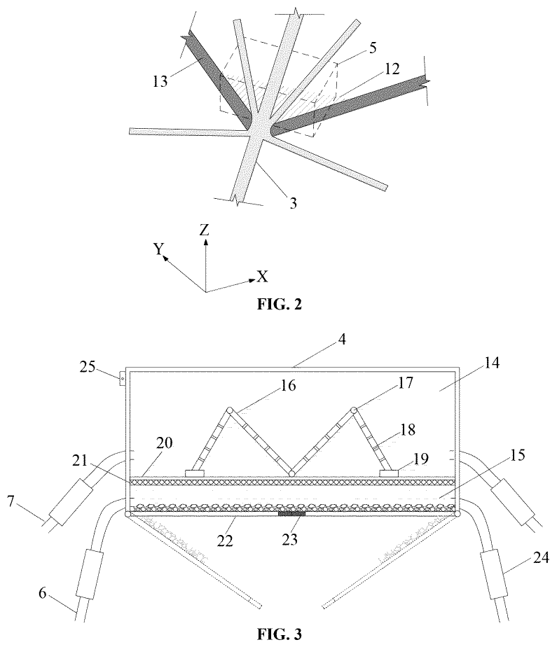

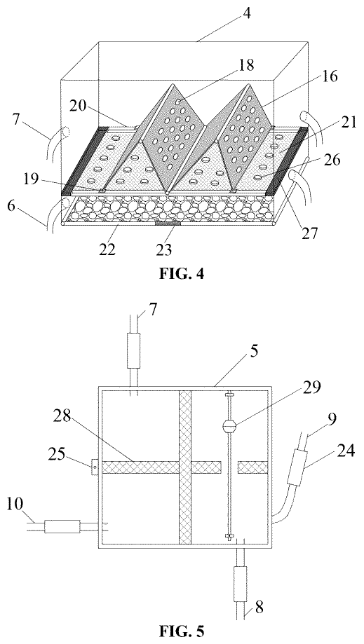

FIG. 1 shows the overall schematic diagram of jacket foundation in the example of the present disclosure; FIG. 2 shows the local node strengthening solution of jacket and the installation schematic diagram of distributed liquid tanks; FIGS. 3 and 4 show the internal structure plane and three-dimensional schematic diagram of central liquid tanks, respectively; and FIG. 5 shows the internal structure plane schematic diagram of distributed liquid tanks. As shown in the figures, this example provides a foundation form of offshore wind power jacket with adjustable natural frequency and motion damping:

The jacket structure shown in FIG. 1 has the basic structural elements of the jacket foundation commonly used in engineering, that is, it includes an upper structure 1, a working platform 2 and a jacket body 3. After the construction of the jacket basic structure is completed, a central liquid tank 4 is installed on the bottom of the working platform by hoisting and transportation, and a central pumping reflux pipeline 6 and a central water transmission pipeline 7 are installed on the side wall of the central liquid tank. Before installing the distributed liquid tank 5, a stiffening plate 12 and a horizontal stiffening rod 13 shown in FIG. 2 are welded at the node of the jacket to ensure that the node of the jacket will not buckle locally due to the gravity load of the tank. After the installation of the distributed liquid tank 5 is completed, the side wall of the distributed liquid tank 5 is sequentially connected with an interlayer water transmission pipeline 8, and an interlayer reflux pipeline 9 and an intralayer infusion pipeline 10 are used for connecting the distributed liquid tank in the lower layer, the distributed liquid tank in the upper layer and the distributed liquid tank in the same layer, respectively. Since the central liquid tank 4 can directly extract seawater to complete liquid storage, there is no need to set a return reflux pipeline 9 between the top distributed liquid tank 5 and the central liquid tank 4. The interlayer water transmission pipeline 8 of the lowest distributed liquid tank 5 is directly connected to seawater, which is convenient for the damper system to quickly discharge excess liquid.

The central liquid tank 4 shown in FIGS. 3 and 4 mainly includes a sediment deposition chamber 15, a liquid storage chamber 14, an M-shaped perforated folding plate 16, a sliding block 19, a slide rail 20, a filter grid 21 and an openable lower baffle 22. Both the M-shaped perforated folding plate 16 and the openable lower baffle 22 are controlled by the central electronic control system. After seawater is directly extracted from the marine environment by the central liquid tank 4, the seawater enters the liquid storage chamber 14 after being filtered by the filter grid 21, and sediment and sundries are deposited in the sediment deposition chamber 15 after standing, thus preventing the sediment from being mixed with the liquid and blocking the infusion pipeline. When the capacity of the sediment deposition chamber 15 is insufficient, the M-shaped perforated folding plate 16 is controlled by the central electronic control system to be stretched and laid flat on the filter grid 21, and the folding and stretching actions of the folding plate can be realized through the cylindrical hinge 17, the sliding block 19 and the slide rail 20. When the folding plate is completely tiled, the waterproof rubber protrusions pre-installed on the filter grid 21 will be completely embedded in the drainage holes 18 of the folding plate, and by combining the waterproof rubber strip 27 pre-installed on the filter grid 21, the liquid storage chamber 14 and the sediment deposition chamber 15 will be completely isolated from the filter grid after the folding plate is tiled, that is, the filtered liquid will be completely sealed in the liquid storage chamber. By opening the openable lower baffle 22 at the bottom of the central liquid tank 4 through the central electronic control system, the sediment can be discharged back into the seawater. After the sediment is discharged into the sea, the central electronic control system closes the lower baffle 22 and retracts the M-shaped perforated folding plate 16 to facilitate the next pumping activity. The M-shaped folding plate 16 not only has the function of sealing the liquid storage chamber 14, but also suffers resistance when the structure shakes and the liquid flows through the drainage holes 18 on the folding plate, further increasing the motion damping of the central liquid chamber. In order to ensure good waterproof and sealing performance inside the device, a waterproof rubber strip 27 is installed at the end of the slide rail 20, and a waterproof rubber joint 23 is installed at the opening of the openable lower baffle 22. The control method of the folding extension of the M-shaped perforated folding plate 16, the structure and control method of the openable lower baffle 22 are not limited in the present disclosure. According to a specific example of the present disclosure, it can be realized in the following ways: a crawler belt is arranged at the contact part between the bottom of the sliding block 19 and the slide rail 20, and a driving motor is installed inside the sliding block 19, so that the sliding block 19 moves back and forth by controlling the forward (reverse) transmission of the crawler belt, thereby realizing the opening and closing of the M-shaped perforated folding plate 16; a rotating motor is built into the rotating shaft of the openable lower baffle plate 22, and the baffle plate can be opened and closed by controlling the motor to rotate clockwise (counterclockwise).

The distributed liquid tanks 5 shown in FIG. 5 are installed at the key nodes of jacket structure, and all jacket nodes with the same height (same floor) need to be installed with the distributed liquid tanks. The liquid migration in the damper system is completed between the liquid tanks in the same floor and different floors through the interlayer water transmission pipeline 8, the interlayer reflux pipeline 9 and the intralayer infusion pipeline 10. Damping nets 28 in different directions are installed in the distributed liquid tank 5, which can provide additional resistance when the liquid in the liquid tank sloshes, thereby increasing the energy consumption of the damper. A liquid level gauge 29 is installed in each liquid tank to measure the liquid level in the bin in real time. By changing the mass of the inner body of the liquid tank, the natural frequency of the liquid tank is changed, so as to realize the effect of tuning the damper.

After the basic construction of jacket and liquid damper system is completed, the natural frequency and motion damping of jacket foundation can be adjusted in real time by combining flow monitoring and control system and acceleration data acquisition and analysis system:
1. The central liquid tank 4 draws seawater through the water pump 24 and the central pumping pipeline 6, and the seawater enters the liquid storage chamber 14 after being filtered by the filter grid 20. The sediment in the seawater remains in the sediment deposition chamber 15 after standing and separating. After the liquid storage volume of the central liquid tank reaches the required value, the excess liquid flows into the distributed liquid tank 5 layer by layer through the central water transmission pipeline 7. When each liquid tank is filled with liquid, the flow monitoring and control system calculates the current liquid storage volume of each liquid tank according to the flow data of each infusion channel measured by the flowmeter 11, and adjusts the liquid mass distribution proportion in each liquid tank according to the overall mass and natural frequency of the jacket. When the ratio of the natural frequency of the tuned liquid damper to the overall first-order natural frequency of the jacket is 0.9-1.1 and the ratio of the total mass of the damper to the overall mass of the jacket is 1.7%-2.3%, the damping effect of the damper system is the best. The overall first-order natural frequency of jacket can be calculated according to the frequency based on numerical simulation software such as ANSYS (refer to the Dynamic Characteristics Analysis of H-type Offshore Dynamic Derrick [J]. Oil Field Machinery, 2007), and the natural frequency of liquid tank can be calculated based on the following equation:

$$\overline{ω} = \sqrt{g π \frac{m}{L} [ tan h ( \frac{π m}{L} H ) ]}$$

where H is the height of the liquid in the liquid tank, L is the distance between the front and rear inner walls of the liquid tank, m takes a constant value of 1, g is the acceleration of gravity, and x is the circular constant.
2. When the jacket structure is subjected to external dynamic load to generate vibration response, the acceleration data acquisition and analysis system acquires the acceleration data at the top and key nodes of the jacket through the triaxial accelerometer 25 installed on the outer wall of the liquid tank, so as to calculate the current external load frequency. Based on the natural frequency of the current jacket structure and the distribution of motion damping of each node, the acceleration analysis system determines the minimum number of liquid tanks to be mobilized in combination with the external load frequency and its distribution data, and adjusts the shortest drainage path of the liquid storage volume of each liquid tank, thus determining the optimal solution for adjusting the natural frequency and damping distribution of the current jacket, and transmitting the reference value of the liquid storage volume required by each liquid tank to the flow monitoring and control system.
3. The flow monitoring and control system controls the water pump 24 to complete the liquid pumping and discharging activities through the electric control system after receiving the reference value of the liquid storage required by each liquid tank, and the liquid in each distributed liquid tank can complete the liquid storage redistribution adjustment in the shortest time through the interlayer water transmission pipeline 8, the interlayer reflux pipeline 9 and the intralayer infusion pipeline 10, thus reducing the influence of external dynamic load on the overall stability of the structure in time.

What has been described above is only the preferred embodiment of the present disclosure, and it is not intended to limit the present disclosure. For those skilled in the art, the present disclosure may have various modifications and changes. Any modification, equivalent substitution, improvement and the like made within the spirit and principle of the present disclosure shall be included in the protection scope of the present disclosure.

What is claimed is:

1. An offshore wind turbine jacket foundation capable with adjustable natural frequency and motion damping, comprising:
a jacket;
a tuned liquid damper system comprising a central liquid tank mounted at a bottom surface of a working platform at a top of the jacket, and multiple distributed liquid tanks arranged at nodes of the jacket, wherein the central liquid tank and the distributed liquid tanks are connected through pipelines and communicated with seawater, and each of the pipelines is provided with a flowmeter and controls liquid transportation by a pump;
an acceleration data acquisition and analysis system comprising acceleration acquisition devices and a data processing system, wherein the acceleration acquisition devices are arranged at key nodes of the jacket foundation and transmit acquired data to the data processing system; and
a flow monitoring and control system comprising the flowmeter, the pump, a data acquisition instrument and a liquid level gauge arranged in each distributed liquid tank, wherein the data acquisition instrument configured to transmit the acquired data to the data processing system, and the flow monitoring and control system is configured to control the pump on each pipeline according to a processing result of the data processing system to realize a redistribution adjustment of liquid storage volumes and liquid levels of seawater in the central liquid tank and each distributed liquid tank, and adjust an overall mass distribution of a structure of the jacket to realize an adjustment and control of the natural frequency and the motion damping of the structure.

2. The offshore wind turbine jacket foundation capable with adjustable natural frequency and motion damping according to claim 1, wherein a side wall of each distributed liquid tank is connected to an interlayer infusion pipeline, an interlayer reflux pipeline and an intralayer infusion pipeline configured to connect distributed liquid tanks at lower layers, distributed liquid tanks at upper layers and distributed liquid tanks at a same layer, respectively, and wherein the central liquid tank is configured to directly extract seawater to complete liquid storage, and no return pipe is provided between a uppermost distributed liquid tank and the central liquid tank, and the interlayer infusion pipeline of a lowermost distributed liquid tank is directly connected to seawater, facilitating the tuned liquid damper system to discharge excess liquid quickly.

3. The offshore wind turbine jacket foundation capable with adjustable natural frequency and motion damping according to claim 2, wherein a filter grid is provided in the central liquid tank to divide an inner space of the central liquid tank into an upper layer and a lower layer; the upper layer is a liquid storage chamber and the lower layer is a sediment deposition chamber; and the sediment deposition chamber is connected to seawater through a pumping pipeline, and the liquid storage chamber is connected to the distributed liquid tanks through a water transmission pipeline; and
wherein the central liquid tank sucks seawater through a central pumping pipeline, sediment separation and liquid filtration are implemented in the sediment deposition chamber, and liquid is injected into the liquid storage chamber; the central liquid tank transports the liquid through the central water transmission pipeline to the uppermost distributed liquid tank, and when the liquid storage demand is met, the excess liquid is transported downward layer by layer through the interlayer infusion pipeline to the distributed liquid tanks at the lower layers; the lowermost distributed liquid tank does not only receive an infusion from the distributed liquid tanks at the upper layers, but also discharges the excess liquid in the tuned liquid damper system back to the ocean through the interlayer infusion pipeline of the lowermost distributed liquid tank; and horizontal liquid delivery is carried out between distributed liquid tanks in the same layer through the intralayer infusion pipeline, and liquid backflow replenishment is realized between two adjacent distributed liquid tanks through the interlayer reflux pipeline.

4. The offshore wind turbine jacket foundation capable with adjustable natural frequency and motion damping according to claim 3, wherein a sliding rail is fixed at the filter grid, and an M-shaped perforated folding plate is provided in the liquid storage chamber; the M-shaped perforated folding plate is formed by sequentially hinging multiple perforated plates through cylindrical hinges; two ends of the M-shaped perforated folding plate are provided with sliding blocks, and the sliding blocks are arranged in the sliding rail and move along the sliding rail; a waterproof rubber strip and multiple waterproof rubber protrusions are fixed at the filter grid; a bottom of the central liquid tank is an openable baffle; the central liquid tank further comprises a central electronic control system configured to control a movement of the sliding blocks to fold or unfold the M-shaped perforated folding plate and control an opening and closing of the openable baffle; and when the M-shaped perforated folding plate is unfolded and flattened, hole positions at the M-shaped perforated folding plate correspond exactly to the waterproof rubber protrusions one by one, and the waterproof rubber protrusions are embedded in holes to completely isolate the liquid storage chamber from the sediment deposition chamber together with the waterproof rubber strip.

5. The offshore wind turbine jacket foundation capable with adjustable natural frequency and motion damping according to claim 4, wherein when a capacity of the sediment deposition chamber is insufficient, the central electronic control system controls the M-shaped perforated folding plate to be stretched and laid flat at the filter grid; when the M-shaped perforated folding plate is completely laid flat, the waterproof rubber protrusions at the filter grid 21 are completely embedded in the holes of the M-shaped perforated folding plate, and completely isolate the liquid storage chamber from the sediment deposition chamber together with the waterproof rubber strip, that is, the filtered liquid is completely sealed in the liquid storage chamber; the openable baffle at the bottom of the central liquid tank is opened by the central electronic control system to discharge sediment back into seawater; and after the sediment is discharged into seawater, the central electronic control system closes the openable baffle and retracts the M-shaped perforated folding plate.

6. The offshore wind turbine jacket foundation capable with adjustable natural frequency and motion damping according to claim 4, wherein damping nets in different directions are provided in the distributed liquid tanks, and the M-shaped perforated folding plate in a folded state and the damping nets are configured to increase a resistance generated by liquid sloshing when the structure vibrates.

7. The offshore wind turbine jacket foundation capable with adjustable natural frequency and motion damping according to claim 1, wherein stiffening plates and horizontal stiffening rods are additionally welded at the nodes of the jacket for installing and fixing the distributed liquid tanks.

8. The offshore wind turbine jacket foundation capable with adjustable natural frequency and motion damping according to claim 1, wherein the data acquisition instrument and the data processing system are integrated into the central control system in an offshore wind turbine cabin; the data acquisition instrument acquires data of each flowmeter and liquid level gauge, and calculates a current liquid storage volume of each distributed liquid tank to obtain a damping distribution; and the data processing system obtains an optimal solution of the natural frequency and the motion damping for adjusting the structure based on the natural frequency and the damping distribution of the current jacket by combining acceleration parameters measured at each node of the jacket, and transmits an adjusted liquid demand of each distributed liquid tank to the flow monitoring and control system to control pumping and discharging of each pump and complete a quality and damping redistribution of the tuned liquid damper system.

9. A control method for the offshore wind turbine jacket foundation capable with adjustable natural frequency and motion damping according to claim 1, wherein the jacket foundation adjusts the natural frequency and the motion damping of the structure in real time, and the control method comprises the following steps:
pumping, by the central liquid tank, seawater, filtering the seawater through the filter grid and entering the liquid storage chamber, standing and separating sediment in the seawater, and leaving the sediment in the sediment deposition chamber; after the liquid storage volume of the central liquid tank reaches a required value, flowing the excess liquid into the distributed liquid tanks below layer by layer through the water transmission pipeline; when the liquid in each distributed liquid tank is filled, the flow monitoring and control system obtaining a current liquid storage volume of each distributed liquid tank according to data measured by each flowmeter and liquid level gauge, and adjusting a liquid mass distribution proportion in each distributed liquid tank according to an overall mass and the natural frequency of the jacket to control a ratio of the natural frequency of the tuned liquid damper to an overall first-order natural frequency of the jacket to be 0.9-1.1 and a ratio of a total mass of the tuned liquid damper to an overall mass of the jacket to be 1.7%-2.3%;
when the structure of the jacket generates a vibration response under an action of an external dynamic load, calculating, by the acceleration data acquisition and analysis system, a current external load frequency by acquiring acceleration data at the top and key nodes of the jacket, obtaining an optimal solution of the adjusted natural frequency and damping distribution of the jacket according to the natural frequency and damping distribution of the structure of the current jacket, and transmitting a reference value of the liquid storage volume required by each distributed liquid tank to the flow monitoring and control system; and
controlling, by the flow monitoring and control system, each pump to complete liquid pumping and discharging activities of the central liquid tank and each distributed liquid tank according to the current liquid storage volume and the reference value of the required liquid storage volume, and realizing the redistribution adjustment of the liquid storage volumes of the central liquid tank and each distributed liquid tank, thereby reducing an influence of the external dynamic load on an overall stability of the structure in time.

10. The control method according to claim 9, further comprising: determining a minimum number of the distributed liquid tanks to be mobilized according to an external load frequency and distribution data of the external load frequency, and adjusting a shortest pumping and drainage path of the liquid storage volume in each distributed liquid tank, so as to determine the optimal solution of the adjusted natural frequency and damping distribution of the jacket.
